(19) United States
(12) Patent Application Publication
(10) Pub. No.: US 2009/0038006 A1
(43) Pub. Date: Feb. 5, 2009

(54) User authentication with image password

(76) Inventors: John L. Traenkenschuh, Mackinaw, IL (US); David W. Gilles, Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/882,553

(22) Filed: Aug. 2, 2007

(51) Int. Cl. H04L 9/32; G06F 3/01

(52) U.S. Cl. 726/21; 715/702

(57) ABSTRACT

A method and apparatus authenticates a user with an image password. In one implementation, a method is provided. According to the method, a plurality of icons are displayed. The plurality of icons are arranged in a pattern. The method receives a sequence of selected inputs. Each of the inputs corresponds to one of the plurality of icons. The method further repositions the plurality of icons after each input and determines whether the user is authenticated based on the received sequence.

### TECHNICAL FIELD

The present disclosure relates generally to user authentication, and more particularly, to a method and apparatus for authenticating a user based on a password selected from images.

### BACKGROUND

Authentication methods typically require a user to provide identifiers (e.g., credentials) that are evaluated to determine whether the user is authorized. Such methods may determine whether users are authorized to access things in the digital realm (e.g., computer systems, files, accounts, websites, etc.) and in the physical world (e.g., buildings, rooms, vehicles, etc.). As part of certain authentication processes, the user must typically provide an identifier that is specific to the user and that may be publicly known (e.g., a username) and a secret identifier that is specific to the user (e.g., a password). The username and password are typically comprised of characters, such as letters, numbers, and symbols that are found in the Arabic character set. The identifiers provided by the user are then compared against identifiers that correspond to authorized users.

The above-described authentication method may universally apply to many situations in which a user is authenticated. For example, e-mail applications and websites (e.g., online accounts, shopping, discussion forums, etc.) make use of this method. Furthermore, this method may also be used to authenticate the identity a user of a machine (e.g., a fixed or mobile commercial machine, such as a construction machine, fixed engine system, marine-based machine, etc.). In connection with the authentication of a machine user, however, this method may present several challenges or difficulties to the manufacturer of the machine and the machine user.

Machines are sold in the global marketplace, which may present difficulties for manufacturers that use traditional authentication methods. For example, users of the machines might use a character set that is limited to a certain geographical region of the world. Although Arabic characters may be suitable for machines sold to certain geographical regions, the manufacturer may need to change authentication software in other geographic regions to process other character sets. From the manufacturer's perspective, it is costly to modify the authentication software per each geographical region. Furthermore, customizing the authentication software for a particular geographic region limits the machine's use to that region unless the software is updated for use in another region.

Difficulties are also encountered by machine users. For authentication purposes (such as providing access to a machine's cab and/or to start a machine's engine), the user of the machine must remember the identifiers, which are sometimes complex and difficult to remember. It is generally accepted that human recall of visual images is more accurate than recall of letters and numbers. For users of machines that wear work gloves, typing a username and password is often time consuming and cumbersome. For example, machine users wearing work gloves may not easily type using a keyboard or keypad. Moreover, certain machine environments might result in damage to a traditional input device, such as a keyboard or keypad.

U.S. Patent Application Publication No. 2004/0030934 A1 (the '934 publication) to Mizoguchi et al. discloses a password interface application. According to the '934 publication, the password interface application presents arrays of images or other sensory cues for display or playback on a client device. A user selects one object from each of the successively presented arrays to define a complete password. However, the password interface application of the '934 publication does not disclose a method or apparatus for authenticating a user in which a user interface repositions images during authentication. Furthermore, the '934 publication does not disclose an input device that is suitable for a variety of machine environments.

Disclosed embodiments are directed to overcoming one or more of the problems set forth above.

### SUMMARY OF THE INVENTION

In one aspect, the present disclosure is directed to a method for authenticating a user. The method may display a plurality of icons. The plurality of icons may be arranged in a pattern. The method may further receive a sequence of selected inputs. Each of the inputs may correspond to one of the plurality of icons. The method may further reposition the plurality of icons after each input and determine whether the user is authenticated based on the received sequence.

In another aspect, the present disclosure is directed to an apparatus for authenticating a user. The apparatus may comprise a display device. The display device may display a plurality of icons arranged in a pattern. The apparatus may further comprise a processor. The processor may execute program instructions for receiving a sequence of selected inputs. Each input may correspond to one of the plurality of icons and the plurality of icons may be repositioning after receiving each input. The processor may further determine whether the user is authenticated based on the received sequence.

It is to be understood that both the foregoing general description and the following detailed description are exemplary and explanatory only and are not restrictive of the invention or embodiments thereof, as claimed.

### BRIEF DESCRIPTION OF THE DRAWINGS

The accompanying drawings, which are incorporated in and constitute a part of this disclosure, illustrate various embodiments. In the drawings:

FIG. 1 is an example of a system for authenticating a user;

FIG. 2 is an example of a user interface for authenticating a user;

FIG. 3 is a flow diagram of an example of a method for authenticating a user;

FIG. 4A is an example of an input device; and

FIG. 4B is an example of an input device and a user interface.

### DETAILED DESCRIPTION

Reference will now be made in detail to the following exemplary embodiments, which are illustrated in the accompanying drawings. Wherever possible, the same reference numbers will be used throughout the drawings to refer to the same or like parts.

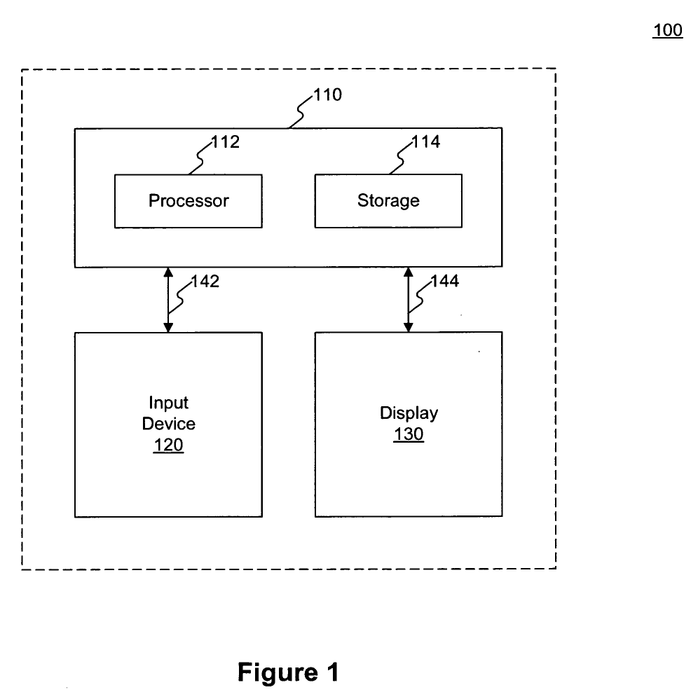

FIG. 1 is an example of an apparatus 100 for authenticating a user. In particular, apparatus 100 may include a computer 110, an input device 120, and a display 130. Furthermore, computer 110 may connect via data link 142 to input device 120 and via data link 144 to display 130. Data links 142 and 144 may include any number of components or links. For example, data links may constitute wires or portions of a circuit board. Although apparatus 100 depicts computer 110, input device 120, and display 130 as being connected via data links 142-144, these components may alternatively communicate wirelessly. Moreover, in some implementations, input device 120 and display 130 may be combined (e.g., a touch screen).

A network (not shown) may interface with and/or provide communications between the various components in apparatus 100, such as computer 110, input device 120, and display 130. In addition, computer 110 may access other legacy systems (not shown) via the network, or may directly, access legacy systems, databases, or other network applications. For example, computer 110 may access an external server (not shown) to authenticate a user. The network may be a shared, public, or private network, may encompass a wide area or local area, and may be implemented through any suitable combination of wired and/or wireless communication networks. Furthermore, the network may comprise a local area network (LAN), a wide area network (WAN), an intranet, or the Internet.

Computer 110 may constitute a personal computer, network computer, server, or mainframe computer having one or more processors that may be selectively activated or reconfigured by a computer program stored in a storage device. As shown, computer 110 comprises a processor 112 and a storage 114. Processor 112 may execute program instructions stored in storage 114. Storage 114 may constitute any appropriate storage device (e.g., hard disk, floppy disk, or CD-ROM, the Internet or other forms of RAM or ROM). Furthermore, storage 114 may store one or more computer programs for providing authentication functionality.

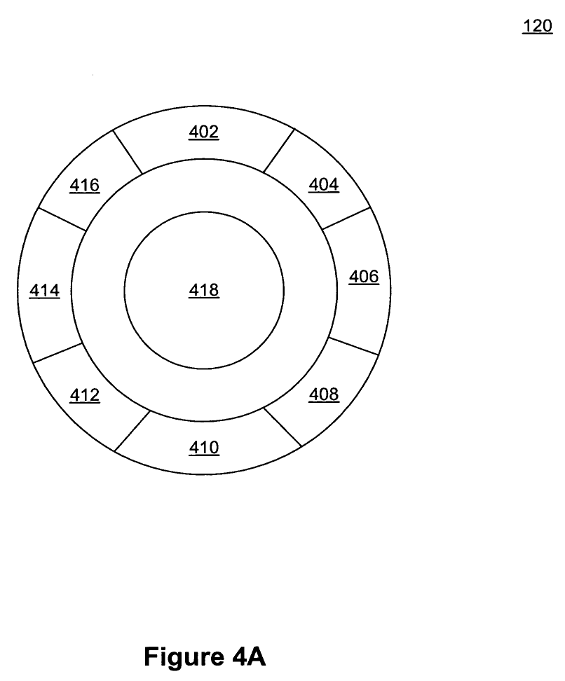

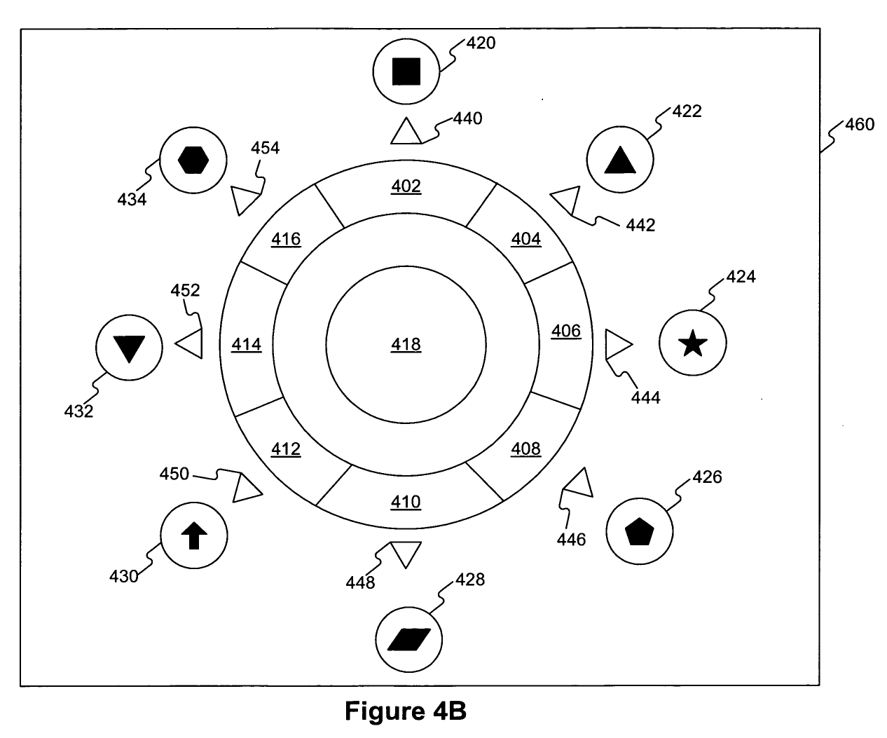

Input device 120 may constitute any appropriate device or devices, which may be directly connected with computer 110. For example, input device 120 may be a handheld device, such as a PDA, cell phone, touch screen, rocker switch, joystick, selectable keys, or keypad. As shown in FIG. 1, input device 120 is connected to computer 110 via data link 142. Alternatively, input device 120 may be provided as a separate component, which may communicate wirelessly with computer 110 via an antenna (not shown) and wireless interface (not shown). Further details concerning input device 120 are provided in connection with FIGS. 4A and 4B.

Display 130 may constitute any appropriate display and may, in some embodiments, comprise a plurality of displays. For example, display 130 may be a monitor, LCD screen, plasma screen, screen of a handheld device, etc. As shown in FIG. 1, display 130 is connected with computer 110 via data link 144. Alternatively, display 130 may communicate wirelessly with computer 110 via an antenna (not shown) and wireless interface (not shown). Furthermore, display 130 may comprise any number of displays that are configured separately or together.

In implementations of disclosed embodiments, computer 110 may authenticate a password of a user comprising icons that are selected by the user. For example, the icons may depict shapes, symbols, animals, plants, objects, faces, locations, photographic images, etc. Furthermore, the icons may be arranged in a pattern, for example, a circular or ring configuration, such that each of the icons is located at one of eight compass points. In order to be authenticated, the user may select a correct sequence of icons. For example, display 130 may depict available icons for selection and a user may input a selected icon using input device 120. Furthermore, after a user selects one or more icons, the icons displayed on display 130 may reposition. For example, computer 110 may reposition the icons after a predetermined number of selections have been received. Accordingly, each icon may rotate or shift one or more positions after one or more selections are received by computer 1 10. In other implementations, computer 110 may present a new group of icons after one or more selections are received.

Implementations may authenticate a user to access computer systems, files, accounts, e-mail applications, websites (e.g., online accounts, shopping, discussion forums, etc.), buildings, rooms, vehicles, machines, etc. For example, when authenticating a user to access a machine, a door to the machine cab may unlock or a user may operate the machine (e.g., may start the engine). Implementations may work in conjunction with other authentication devices and/or procedures. For example, a user may insert a key (or machine-readable keycard) into a machine to unlock a door or start an engine and then be required to enter a password according to disclosed embodiments before apparatus 100 will generate a signal that unlocks a door or starts the engine of the machine.

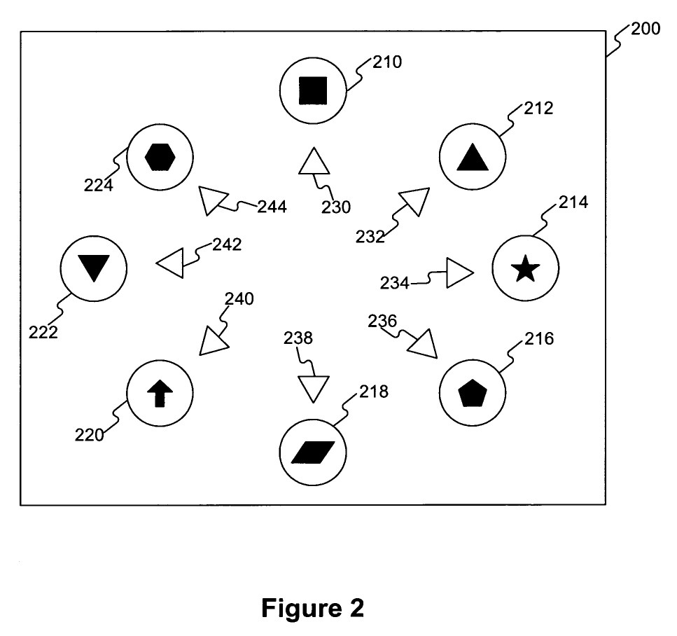

FIG. 2 is an example of a user interface 200 for authenticating a user. Computer 110 may display user interface 200 on display 130. User interface 200 includes icons 210-224 and selection arrows 230-234. Icons 210-224 may comprise images of any kind, such as shapes, symbols, animals, plants, objects, faces, locations, photographic images, etc. Preferably, icons 210-224 are images that do not include letters and/or numbers. Images may -be black and white, a single color, or multiple colors. As shown in FIG. 2, icons 210-224 are shapes (e.g., square, triangle, star, pentagon, parallelogram, upward arrow, inverted triangle, hexagon). Although FIG. 2 depicts all shapes, one of ordinary skill will recognize that categories of images may be combined (e.g., some of icons 210-224 may depict shapes, others may depict animals, etc.). Furthermore, some images may appear more than once, but repeated images may each have a different color (e.g., a blue square and a red square).

As shown in FIG. 2, icons 210-224 are arranged in a circular or ring configuration, such that each of icons 210-224 is located at one of eight compass points. However, one of ordinary skill in the art will appreciate that icons 210-224 may be arranged according to any other shape or pattern (e.g., triangular, a grid, etc) and the number of icons may vary.

In some implementations, input device 120 and display 130 may be combined (e.g., a touch screen). Accordingly, a user may select one or more of icons 210-224 by direct touch of user interface 200. Thus, icons 21-0224 may constitute inputs. In other implementations, the user may select one or more of icons 210-224 using a separate input device, which is discussed below in further detail. Upon the user's selection of one of icons 210-224, selection arrows 230-234 may provide a confirmation of the selection. For example, if the user selects icon 216, corresponding selection arrow 236 may display a confirmation signal (e.g., light up, highlight, change color, blink, etc.). After a user selects another one of icons 210-224 or after a predetermined time period expires, selection arrow 236 may return to its unselected state.

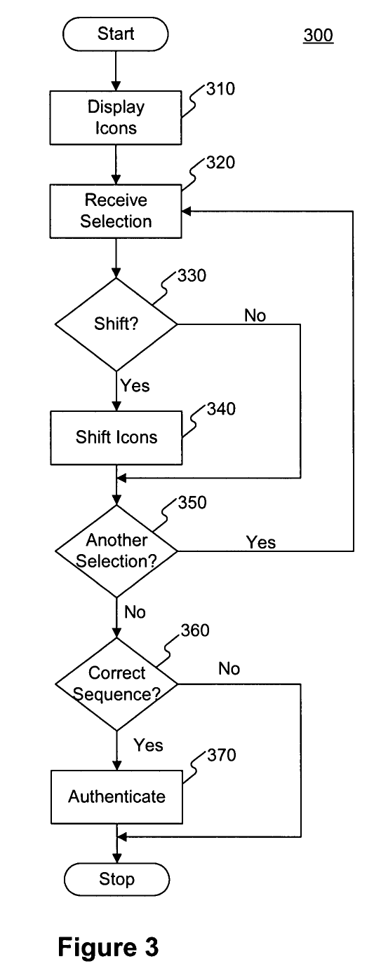

Accordingly, computer 110 may authenticate a password selected from icons 210-224. For example, the user may select a correct sequence of icons. After a user selects one or more of icons 210-224, icons 210-224 may reposition. For example, computer 110 may reposition icons 210-224 after a predetermined number of selections have been received. In one example, icons 210-224 may reposition after each selection. That is, a user may select an icon (e.g., icon 222) and, subsequently, computer 110 may shift or rotate each of icons 210-224 one position in a clockwise or counterclockwise direction. In some implementations, icons 210-224 may reposition after a predetermined number of selections are made (e.g., after one selection, after two selections, after two [symbol] Furthermore, one of ordinary skill in the art will recognize that icons 210-224 may [symbol] ther manner (e.g., icons 210-224 may randomly reposition or may shift multiple [symbol] her implementations, computer 110 may present a new group of icons after one or [symbol] ire received. For example, one or more of icons 210-224 may display a different [symbol] or after one or more selections are made.

[symbol] ng now to FIG. 3, a flow diagram 300 is provided of an, example of a method for [symbol] user. For example, the method may implement one or more processes according to [symbol] ions stored in storage 114 and executed by processor 112. Prior to the start of the [symbol] iay provide a usemame, such as by selecting or entering the user's name, image, or [symbol] ier via input device 120 or by inserting a key or keycard. Next, the method may [symbol] a and determine whether or not the received input data constitutes a valid password [symbol] iding username.

[symbol] ;tart of the process, in step 310, computer 110 may display icons 210-224 on user [symbol] s discussed above, user interface 200 may be displayed on display 130. [symbol] rinterface 200 may include selection arrows 230-244 to confirm selections. [symbol] 3 step 320, computer 110 may receive a selection of one of icons 210-224. For [symbol] ter 110 may receive the selection from input device 120. Input device 120 may [symbol] propriate device and is discussed below in further detail.

[symbol] 330, computer 110 may determine whether to shift icons 210-224. In some [symbol] a shift of icons 210-224 may occur after each selection or after multiple selections. [symbol] determines that icons 210-224, based on program instructions for the presently [symbol] s, should shift, then the process proceeds to step 340. If computer 110 determines [symbol] !4 should not shift, then the process proceeds to step 350.

[symbol] 340, computer 110 shifts icons 210-224. As disclosed herein, a shift of icons [symbol] lude any repositioning, change, rotation, or alteration of icons 210-224. For [symbol] ter 110 may shift or rotate each of icons 210-224 one position in a clockwise or [symbol] >direction, icons 210-224 may randomly reposition, icons 210-224 may shift [symbol] is at a time, etc. Alternatively, in step 340, computer 110 may present, via user interface 200, a new group of icons after one or more selections are received or one or more of icons 210-224 may change to display a different image and/or different color.

In step 350, computer 110 may determine whether the password requires further selections. For example, the password may include three icons (e.g., the password is star, upward arrow, and pentagon). If the password requires further selections, the process returns to step 320. If the password does not require further selections, then the process proceeds to step 360.

In step 360, computer 110 may determine whether or not the received sequence oficons-constitutes a valid password for the user. Validation of the password may alternatively be performed by an authentication server (not shown) available over a network (not shown). For example, computer 110 may transmit, in a secure fashion, data for the received username and password combination to the authentication server, which may then return a response indicating whether the username and password combination are correct. If the username and password are correct, then the process proceeds to step 370. However, if the username and password are not correct, then the process ends. In the event that computer 110 receives an incorrect username and password combination, computer 110 may display an appropriate error message on user interface 200 (e.g., “The password is not valid.”) and may provide the user with a predetermined number of chances to repeat the process correctly (e.g., “Please try again.”).

In step 370, computer 110 may authenticate the user. For example, computer 110 may authenticate the user to access computer systems, files, accounts, e-mail applications, websites (e.g., online accounts, shopping, discussion forums, etc.), buildings, rooms, vehicles, machines, etc. When authenticating a user to access a machine, a door to the machine cab may unlock or a user may operate the machine (e.g., the user may start the engine).

As one of ordinary skill in the art will appreciate, one or more of steps 310-370 may be optional and may be omitted from implementations in certain embodiments.

FIG. 4A is an example of input device 120. As shown in FIG. 4A, input device 120 comprises portions 402-416, which are arranged in a circular pattern. Portions 402-416 are selectable and may correspond to icons 210-224, respectively. For example, selecting portion 402 may correspond to a selection of icon 210. Furthermore, input device 120 may include portion 418, which may constitute an “enter” or “confirmation” portion. For example, after selecting one of portions 402-416, a user may select portion 418 to signify confirmation of the selection.

A user may select portions 402-418 in a variety of ways. For example, in some embodiments, input device 120 may constitute or be incorporated in and/or with display 130 (discussed in connection with FIG. 4B in more detail). Accordingly, in such an embodiment, portions 402-418 may appear graphically on display 130. In other embodiments, input device 120 may constitute a separate, physical component, such as a rocker switch, joystick, selectable keys, or keypad. That is, in such embodiments, portions 402-418 may constitute separate, physical components or portions thereof, which may be actuated by a user.

FIG. 4B is an example of input device 120 and a user interface 460. For example, computer 110 may display user interface 460 in display 130. User interface 460 may constitute a touch screen including icons 420-435, selection arrows 440-454, and portions 402-418. For example, a user may select portions 402-416 (e.g., by touching the images) to select icons 420-435. Alternatively, portions 402-418 may be omitted and selection may be accomplished by directly touching icons 420-434 and/or selection arrows 440-454 (e.g., as shown in FIG. 2).

As yet another alternative, input device 120 may constitute a physical component integrated with or part of display 130. For example, display 130 may comprise a plurality of display portions that comprise icons 420-434. Selection arrows 440-434 may comprise other display portions or elements (e.g, LEDs, etc.). Portions 402-418 of input device 120 may be implemented with physical components, such as rocker switches, a joystick, selectable keys, or a keypad, etc.

### INDUSTRIAL APPLICABILITY

Disclosed embodiments may authenticate a password of a user comprising icons that are selected by the user. Furthermore, the icons may be arranged in, for example, a circular or ring configuration. In order to be authenticated, the user may select a correct sequence of icons. Furthermore, after a user selects one or more icons, the icons may reposition or change. Disclosed embodiments may provide authentication functionality for a variety of applications. For example, disclosed embodiments may authenticate a user to access computer systems, files, accounts, e-mail applications, websites (e.g., online accounts, shopping, discussion forums, etc.), buildings, rooms, vehicles, machines, etc. When authenticating a user to access a machine, a door to the machine cab may unlock or a user may operate the machine (e.g., may start the engine). Implementations may work in conjunction with other authentication devices and/or procedures. For example, a user may insert a key to unlock a door or start an engine (e.g., constituting the username) and then be required to enter a password according to disclosed embodiments before the door will unlock or the engine will start.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments. For example, the described implementations include software, but systems and methods consistent with the present invention may be implemented as a combination of hardware and software or in hardware alone. Examples of hardware include computing or processing systems, including personal computers, servers, laptops, mainframes, microprocessors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Computer programs based on the written description and methods of this invention are within the skill of an experienced developer. The various programs or program modules can be created using any of the techniques known to one skilled in the art or can be designed in connection with existing software. For example, program sections or program modules can be designed in or by means of Java, C++, HTML, XML, or HTML with included Java applets. One or more of such software sections or modules can be integrated into a computer system or browser software.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. Further, the steps of the disclosed methods may be modified in any manner, including by reordering steps and/or inserting or deleting steps, without departing from the principles of the invention. It is intended, therefore, that the specification and examples be considered as exemplary only, with a true scope and spirit of the invention being indicated by the following claims and their full scope of equivalents.

What is claimed is:

1. A method for authenticating a user, the method comprising:
displaying a plurality of icons, wherein the plurality of icons are arranged in a pattern;
receiving a sequence of selected inputs, wherein each of the inputs corresponds to one of the plurality of icons;
repositioning the plurality of icons after each input; and
determining whether the user is authenticated based on the received sequence.

2. The method of claim 1, wherein each of the plurality of icons is displayed adjacent to a corresponding input device.

3. The method of claim 1, wherein each of the plurality of icons is selectable from a touch screen.

4. The method of claim 1, wherein the pattern is circular in shape.

5. The method of claim 1, wherein during the repositioning of the plurality of icons, the plurality of icons shift at least one position in a clockwise or counterclockwise direction.

6. The method of claim 1, wherein during the repositioning of the plurality of icons, the plurality of icons randomly shift positions.

7. The method of claim 2, wherein selection arrows are positioned between each of the plurality of icons and the corresponding input device.

8. The method of claim 1, wherein when the user is authenticated, the method further comprises unlocking a machine door.

9. The method of claim 1, wherein when the user is authenticated, the method further comprises starting a machine engine.

10. The method of claim 1, wherein program instructions comprising the method are stored in a computer-readable medium.

11. An apparatus for authenticating a user, the apparatus comprising:
a display device, wherein the display device displays a plurality of icons arranged in a pattern;
a processor, the processor executing program instructions for receiving a sequence of selected inputs, wherein each input corresponds to one of the plurality of icons and the plurality of icons are repositioning after receiving each input, the processor further determining whether the user is authenticated based on the received sequence.

12. The apparatus of claim 11, further comprising:
a plurality of input devices, wherein each of the plurality of icons is displayed adjacent to a corresponding of the plurality of input devices.

13. The apparatus of claim 11, wherein each of the plurality of icons is selectable by touching the display device.

14. The apparatus of claim 11, wherein the pattern is circular in shape.

15. The apparatus of claim 11, wherein during the repositioning of the plurality of icons, the plurality of icons shift at least one position in a clockwise or counterclockwise direction.

16. The apparatus of claim 11, wherein during the repositioning of the plurality of icons, the plurality of icons randomly shift positions.

17. The apparatus of claim 12, wherein the processor receives a selection of one of the plurality of icons upon actuation of the corresponding input device.

18. The apparatus of claim 12, wherein selection arrows are positioned between each of the plurality of icons and the corresponding input device.

19. The apparatus of claim 11, wherein when the user is authenticated, the processor causes a machine door to unlock or a machine engine to start.

20. A method for authenticating a user, the method comprising:
receiving an identity of user;
displaying a plurality of icons, wherein the plurality of icons are arranged in a pattern on a touch screen;
receiving a sequence of selected inputs received by the touch screen, wherein each of the inputs corresponds to one of the plurality of icons;
repositioning the plurality of icons after each input; and
determining whether the user is authenticated based on the identify of the user and the received sequence.
